(19) United States
(12) Patent Application Publication
(10) Pub. No.: US 2019/0105940 A1
(43) Pub. Date: Apr. 11, 2019

(54) Clip for Mounting a Calendar and Method of Hanging a Calendar Using the Clip

(71) Applicant: Joseph A. Overly, Fiskdale, MA (US)

(72) Inventor: Joseph A. Overly, Fiskdale, MA (US)

(21) Appl. No.: 16/149,776

(22) Filed: Oct. 2, 2018

Related U.S. Application Data
(60) Provisional application No. 62/569,488, filed on Oct. 7, 2017.

(51) Int. Cl. B42F 1/02; F16M 13/02

(52) U.S. Cl. CPC B42F 1/02; F16M 13/02

(57) ABSTRACT

A clip for mounting a calendar that has a hanging page with a hanging hole near the top. The clip has a front clip portion and a rear clip portion. The two portions are adapted to be moved apart and together so as to selectively grasp one or more pages of a calendar. There is a slot in the bottom of the rear portion. There is also a hook member or a peg member on the rear portion. There may be a guide portion in the center on the bottom of the rear portion. This guide allows the calendar hanging page to be easily pushed up into the slot in the rear portion of the clip such that the hanging hole can be placed over the hook member or onto the peg member, so that the clip can hold the calendar. The clip can be fixed to a surface such as a wall, so as to hang the calendar from a wall.

### CROSS-REFERENCE TO RELATED APPLICATION

This application claims priority of Provisional Application 62/569,488, filed on Oct. 7, 2017.

### FIELD

This application relates to a clip that can be used to hang a calendar.

### BACKGROUND

Some yearly calendars include a front cover page and a page for each month. The pages have holes near the top that allow the calendar to be hung from a hook or push-pin, for example. Each month the calendar needs to be removed from the hanger, the page turned, and then re-hung. If the hanger puts a hole in the wall, the hole will grow over time.

### SUMMARY

All examples and features mentioned below can be combined in any technically possible way.

In one aspect, a clip for mounting a calendar that comprises a plurality of pages including a hanging page with a hanging hole near the top includes a front portion and a rear portion, the portions adapted to be moved apart and together so as to selectively grasp one or more pages of a calendar, a projecting member on the rear portion, and a slot in the bottom of the rear portion. The slot allows the hanging page to be pushed up into the rear portion such that the hanging hole can be placed over the projecting member to hang the calendar by the hanging page.

Embodiments may include one of the above and/or below features, or any combination thereof. The projecting member may comprise a peg. The projecting member may comprise a hook. The projecting member may project outwardly from the rear member, toward the front member. The rear portion may have a bottom with a center, and the clip may further comprise a guide member in the center on the bottom of the rear portion. The guide member may comprise a tab. The tab may be located below and just underneath the slot, so that it is configured to guide the hanging page into the slot. The rear portion of the clip may further comprise two page tensioning members spaced an equal distance from the projecting member. The page tensioning members may comprise arc-shaped anus with free lower distal ends that define an open space into which the hanging page can fit, wherein the page tensioning members put tension on the hanging page to help maintain the hanging page in the slot.

In another aspect, a method for mounting a calendar that comprises a plurality of pages including a hanging page with a hanging hole near the top includes providing a clip comprising a front portion and a rear portion, the portions adapted to be moved apart and together so as to selectively grasp one or more pages of a calendar; a projecting member on the rear portion; and a slot in the bottom of the rear portion; wherein the slot allows the hanging page to be pushed up into the rear portion such that the hanging hole can be placed over the projecting member to hang the calendar by the hanging page; pushing the hanging page into the slot until the hanging hole is over the projecting member; and placing used calendar pages between the front and rear portions of the clip.

### BRIEF DESCRIPTION OF THE DRAWINGS

FIG. 1 is a perspective view of a clip holding a calendar.

FIG. 2 is a front view of the front portion of the clip of FIG. 1.

FIG. 3 is a rear view of the front portion of the clip of FIG. 1.

FIG. 4a is a rear view of the rear portion of the clip of FIG. 1.

FIG. 4B is a close-up view of the hanging page guide shown in FIG. 4A.

FIG. 5 is a side view of the clip of FIG. 1

FIG. 6 is a close-up view of a peg that can be used to hang the calendar.

FIG. 7A is a side view of the rear portion of the clip of FIG. 1 and FIG. 7B is a partial view thereof, detailing an arm and a peg.

FIG. 8 is a side view of the clip of FIG. 1 holding a calendar.

### DETAILED DESCRIPTION

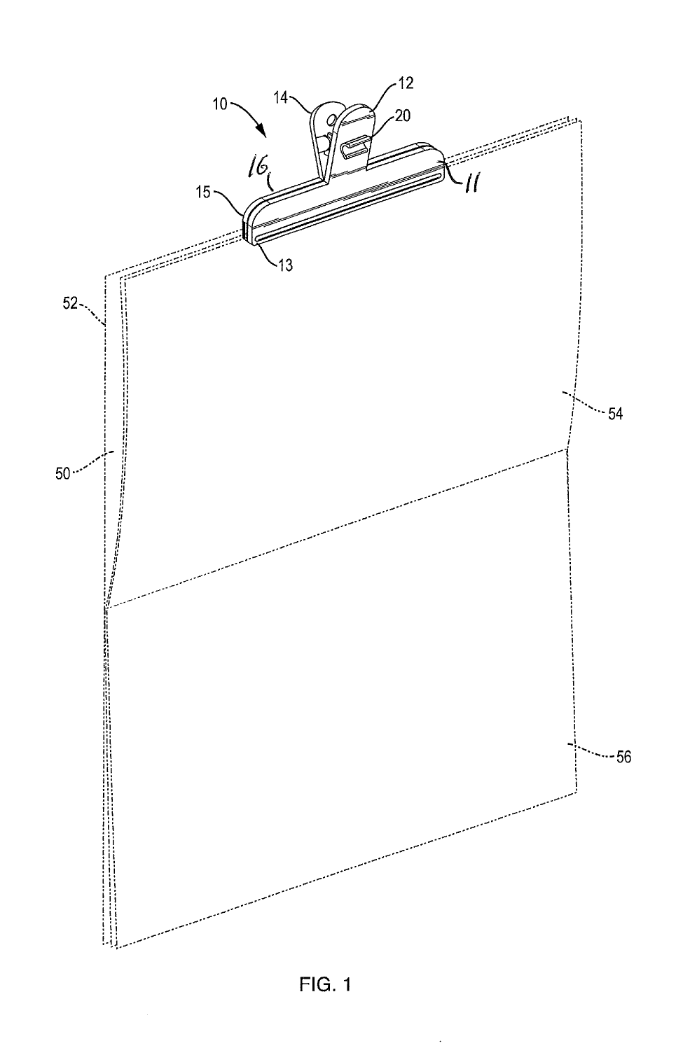

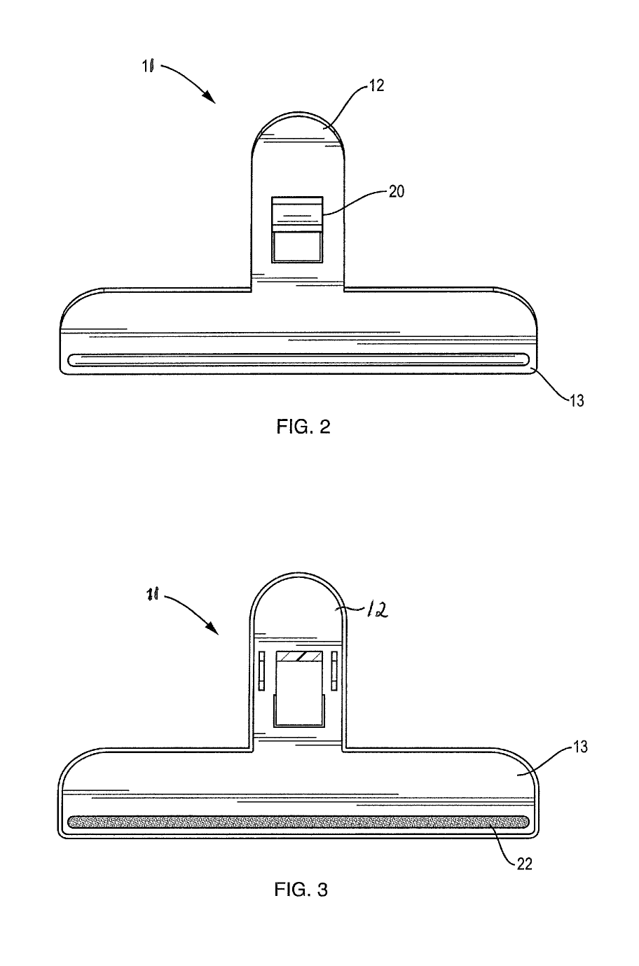

A non-limiting example of the clip is shown in FIGS. 1-8. FIG. 1 is a front view of the clip 10 that allows multi-page calendar 50 (shown in phantom) to be hung on a surface such as a wall or refrigerator, for example. FIG. 2 is a front view of the front portion 11 of clip 10 with clip handle 12 and base 13. FIG. 3 is a rear view of the front portion 11 of the clip showing clip handle 12 and base 13 with grippy strip 22.

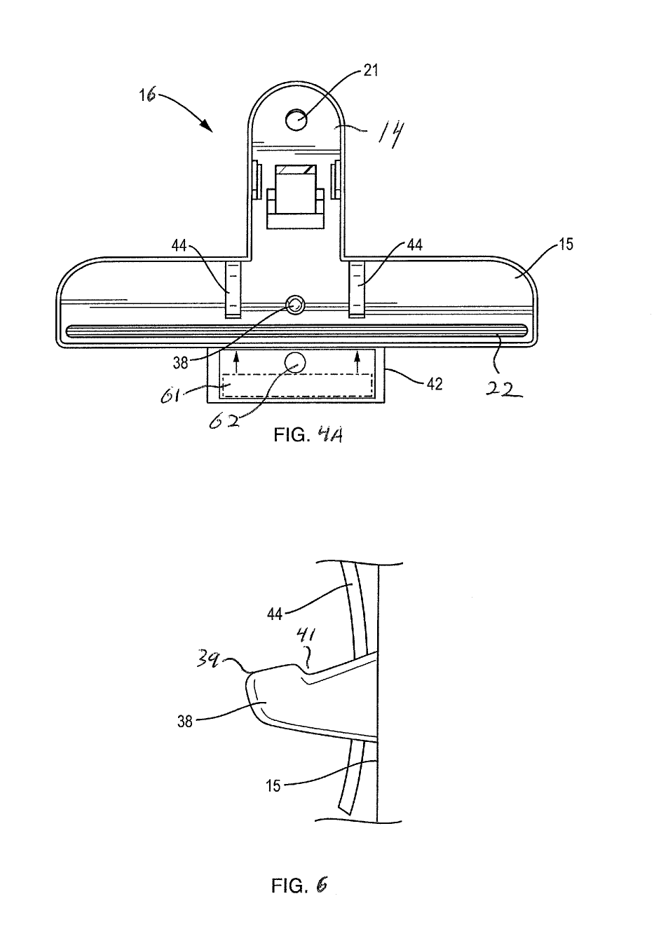

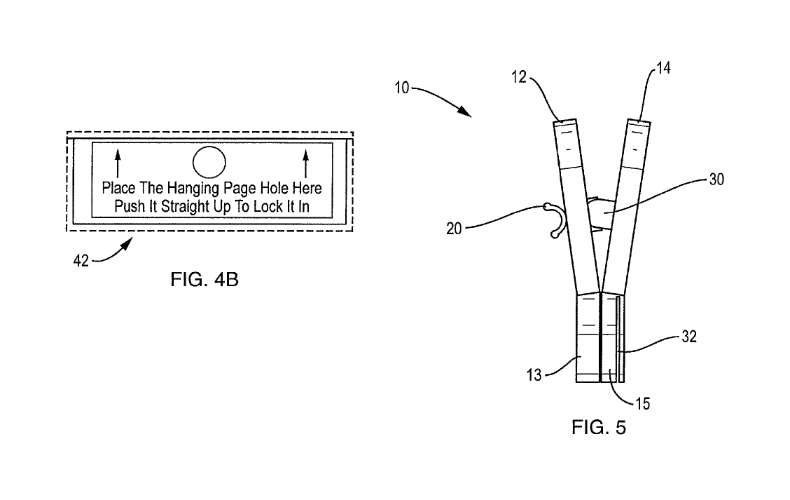

FIG. 4A is a front view of the rear portion 16 of the clip showing rear portion handle 14 and rear portion base 15. When the handles of the front and rear portions are squeezed together, the portions pivot about pivot member 30 and bases 13 and 15 separate. A spring (not shown) urges the portions back together when the handles are released. Handle 14 has opening 21 that allows clip 10 to be hung from a wall. e.g., with a nail or pin, or using a picture hook or Velcro hanger for example. The clip can also or alternatively have a magnet (not shown) that allows it to stick to a magnetic surface. Other means and structures for mounting clips to a surface are known and included within the scope of the invention. For example, the back side of the rear portion of the clip can carry any type of mounting structure. In order to facilitate mounting the clip to a fabric surface (such as, for example, a fabric-type cover of a typical office cubical/work station wall or separator) the clip can carry one or more pins (not shown) that can be pushed into the fabric. Integral pencil holder 20 may be included to keep a writing implement handy as shown in FIG. 5. One or both clip portions may include a grippy strip 22 (e.g., a thin rubber strip) on the inside, near the bottom. The grippy strip(s) can help to hold up calendar pages between the clip portions, as described below.

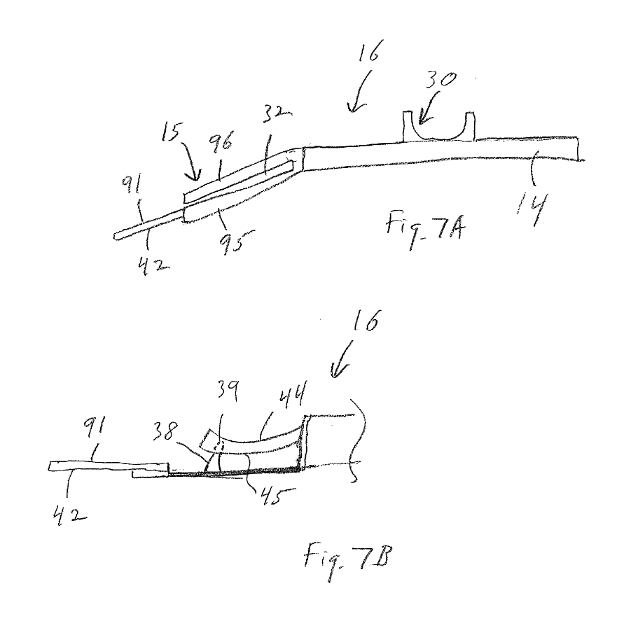

Rear portion base 15 has vertical slot 32 that spans the entire width of the base 15. Slot 32 allows calendar hanging page 52 to be pushed up into the clip. Projecting member 38 (which may be a peg or a hook, for example) projects from the rear portion a short distance toward the front portion. Member 38 preferably has an angle along its length or at least at its tip, as shown in FIG. 6.

FIG. 4B shows calendar hanging page guide 42. This guide may be a tab than hangs down below the bottom center of the rear clip portion and is just underneath the slot 32, so that the calendar hanging page can be pushed up along the top surface of the tab and slid into slot 32. Optional text in area 61 (see FIG. 4B) can provide directions for inserting the calendar hanging page into slot 32 and making it easier to align and place the calendar hanging page hole onto member 38. The directions can be in area 61 and there can also be a printed circle 62. The directions can read “Place the hanging hole here push it straight up to lock in” where “here” refers to the circle 62 over which the hanging page hanging hole can be placed to properly align the hanging hole with member 38, so that the hole slips over member 38 when the page is pushed up.

In one non-limiting example, member 38 may be a hook member that may be ⅛″ high, 1/16″ wide and the hook portion may be cut at a 45-degree angle. In another example (shown in the drawings, e.g., FIG. 6) a peg member 38 may be at an angle to the clip body and have an angled indentation 41 on its top surface as shown, for holding a calendar hanging page securely in place. In one non-limiting example, peg member 38 may be ¼″ long and 3/16″ round.

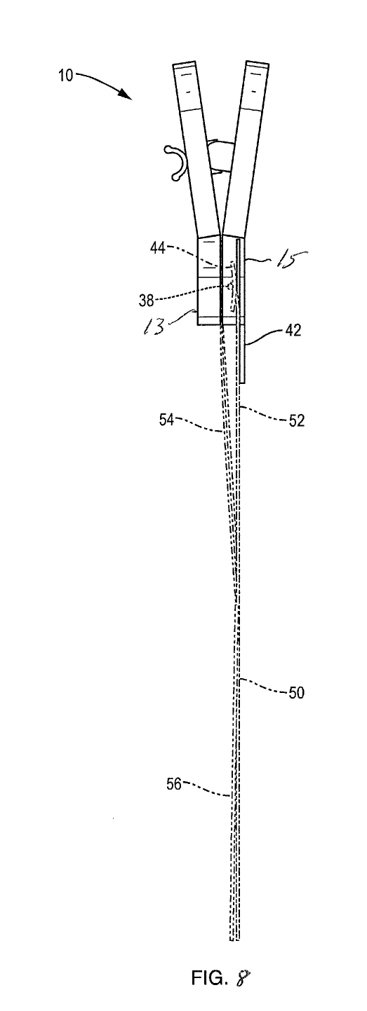

FIG. 4A shows two spaced arc-shaped arms 44 with free lower distal ends that define an open space into which the hanging page can fit. See also FIG. 7B. Arms 44 put tension on the hanging page to help maintain the hanging page in the slot. Arms 44 can be positioned at an equal space to the right and left of member 38. These arms are curved in an arc, in such a way as to put tension on the calendar hanging page when inserted into slot 32, making it easier to place the calendar hanging page hole onto peg 38. In other words, arms 44 help to push the hanging page down over member 38. Arms 44 are optional and may not be included, particularly in a smaller version of the clip.

FIG. 7A is a side view of rear portion 16. Base 15 has slot 32 formed between upper base portion 96 and lower base portion 95. Since rear portion 16 is a molded plastic unitary member, and since base portion 96 is cantilevered, portion 96 is flexible. As the hanging page is pushed up along top surface 91 of guide member 42 it enters slot 32 and may push portion 96 slightly up. Since distal end 39 of peg 38 is higher than the bottom surface 45 of arm 44, arm 44 contacts and places downward pressure on the hanging page. This pressure helps to keep the page from floating up and not engaging over peg 38. When the hole near the top center of the hanging page reaches peg 38 the page slips over the peg and is held thereon both by gravity as well as the pressure exerted by arm 44. After the calendar has been hung, when monthly pages need to be turned they are flipped up and tucked between clip portions bases 13 and 15, which are urged together by a spring (not shown) that provides sufficient force to hold the used pages up.

FIG. 8 shows a side view of the clip 10 that allows multi-page calendar 50 (shown in phantom) to be hung by hanging page 52 hanging from member/peg 38. Used pages 54 are held between front and rear portion ends 13 and 15. Page 56 is the page that carries the current month.

Calendar 50 can be hung from clip 10 by pushing hanging page 52 along guide 42 up into slot 32 and fitting the mounting hole over member 38. It can be removed from member 38 by lifting the calendar hanging page straight up so that it disengages from member 38, and sliding the page to the left or right far enough such that the hanging hole is misaligned with and so will not re-engage member 38. The calendar can then be pulled out of the clip.

The clip allows a calendar to be hung easily without the need to remove the hanging hardware (e.g., nail or push-pin etc.) from the wall, thus preventing multiple puncture holes in the wall. Also, the calendar does not need to be removed from the hanger to change the expired month page. It also keeps a pen or pencil handy.

A number of implementations have been described. Nevertheless, it will be understood that additional modifications may be made without departing from the scope of the inventive concepts described herein, and, accordingly, other embodiments are within the scope of the following claims.

What is claimed is:

1. A clip for mounting a calendar that comprises a plurality of pages including a hanging page with a hanging hole near the top, comprising:
a front portion and an opposed rear portion, the portions adapted to be moved apart and together so as to selectively grasp one or more pages of a calendar;
a projecting member on the rear portion; and
a slot in the bottom of the rear portion;
wherein the slot is configured to allow the hanging page to be pushed through the slot into the rear portion such that the hanging hole is configured to be placed over the projecting member, to hang the calendar by the hanging page.

2. The clip of claim 1, wherein the projecting member comprises a peg.

3. The clip of claim 1, wherein the projecting member comprises a hook.

4. The clip of claim 1, wherein the rear portion has a bottom with a center, the clip further comprising a guide member in the center on the bottom of the rear portion.

5. The clip of claim 4, wherein the guide member comprises a tab.

6. The clip of claim 5, wherein the tab is located below and just underneath the slot, so that it is configured to guide the hanging page into the slot.

7. The clip of claim 1, wherein the rear portion further comprises two page tensioning members spaced an equal distance from the projecting member.

8. The clip of claim 7, wherein the page tensioning members comprise arc-shaped arms with free lower distal ends that define an open space into which the hanging page can fit, wherein the page tensioning members put tension on the hanging page to help maintain the hanging page in the slot.

9. The clip of claim 1, wherein the projecting member projects outwardly from the rear member, toward the front portion.

10. A method for mounting a calendar that comprises a plurality of pages including a hanging page with a hanging hole near the top, comprising:
providing a clip comprising a front portion and a rear portion, the portions adapted to be moved apart and together so as to selectively grasp one or more pages of a calendar; a projecting member on the rear portion and projecting toward the front portion; and a slot in the bottom of the rear portion, wherein the slot allows the hanging page to be pushed up into the rear portion such that the hanging hole can be placed over the projecting member to hang the calendar by the hanging page;
pushing the hanging page into the slot until the hanging hole is over the projecting member; and
placing used calendar pages between the front and rear portions of the clip.
